(19) United States
(12) Patent Application Publication
(10) Pub. No.: US 2008/0136749 A1
(43) Pub. Date: Jun. 12, 2008

(54) PLASMA DISPLAY DEVICE AND DRIVING METHOD THEREOF

(76) Inventor: Joo-Yul Lee, Suwon-si (KR)

Correspondence Address: CHRISTIE, PARKER & HALE, LLP, PO BOX 7068, PASADENA, CA, 91109-7068, US

(21) Appl. No.: 11/943,559

(22) Filed: Nov. 20, 2007

(30) Foreign Application Priority Data
Dec. 6, 2006 (KR) 10-2006-0122995

(51) Int. Cl. G09G 3/28

(52) U.S. Cl. 345/67

(57) ABSTRACT

The present invention relates to a plasma display device and a driving method thereof. A second voltage higher than a first voltage is applied to second electrodes while the first voltage is applied to first electrodes during at least a portion of a wall charge compensation period occurring between a first period and a second period of an address period. A difference between the first voltage and the second voltage is smaller than that between voltages applied to the first and second electrodes in a sustain period. Further, only when temperature of the plasma display device is higher than a reference temperature, the wall charge compensation period is included. Accordingly, the wall charges lost due to high temperatures may be compensated and a stable address operation can be performed.

### CROSS-REFERENCE TO RELATED APPLICATION

This application claims priority to and the benefit of Korean Patent Application No. 10-2006-0122995 filed in the Korean Intellectual Property Office on Dec. 6, 2006, the entire contents of which are incorporated herein by reference.

### BACKGROUND OF THE INVENTION

1. Field of the Invention

The present invention relates to a plasma display device and a driving method thereof.

2. Description of the Related Art

A plasma display device is a display device using a Plasma Display Panel (PDP) configured to display characters and/or images by employing plasma generated by gas discharge. In the PDP, a plurality of discharge cells are arranged in matrix form.

The plasma display device is driven during frames of time. One frame is divided into a plurality of subfields each having a corresponding weight value. Each subfield includes a reset period, an address period and a sustain period. The reset period is a period in which the state of a discharge cell is reset in order to stably perform address discharge. The address period is a period in which cells to be turned on are selected from a plurality of discharge cells. Finally, the sustain period is a period in which sustain discharge is performed on cells to be turned on in order to actually display an image.

In general, a wall charge state after the reset period is set such that address discharge is performed stably. Furthermore, in the address period, a scan pulse is sequentially applied to all of the scan electrodes and an address voltage is applied to address electrodes corresponding to light-emitting cells, so that the light-emitting cells are selected. The light-emitting cells are the cells that are selected for emitting light during a subsequent sustain period and are some times referred to as on-cells. However, the wall charge state set during the reset period is lost as times passes. Therefore, in the cells corresponding to the scan electrodes to which the scan pulse is applied later, the wall charge state remaining after the reset period may be lost by the time the scan pulse reaches these electrodes. In the case of a discharge cell that is selected later in time, the loss of wall charges may be large. Thus, a low address discharge may occur in a cell that is selected later in time. The loss of wall charges may also increase when the temperature is high or when there are many priming particles.

### SUMMARY OF THE INVENTION

Embodiments of the present invention provide a plasma display device and a driving method thereof, in which stable address discharge can be performed.

One exemplary embodiment of the present invention, provides a driving method of a plasma display device. The plasma display device includes a plurality of first electrodes, a plurality of second electrodes, and a plurality of third electrodes formed in a direction crossing the first and second electrodes. Cells are formed along each electrode where the first and second electrodes cross over the third electrodes. The first electrodes are divided into a first group and a second group. Electrodes of the first group are adjacent one another and electrodes of the second group are also adjacent one another. The plasma display device is driven during frames of time. Each frame is divided into a number of subfields. Each subfield includes an address period followed by a sustain period. During the address period the light-emitting cells that are intended to emit light for forming an image to be displayed are selected. The selected light-emitting cells emit light to form the image being displayed during the sustain period. At least one of the address periods includes a first, a second, and a third period. The method includes, during the first period, applying a scan pulse to the first group for addressing the light-emitting cells formed along the first group, during the second period, while applying a first voltage to the second electrodes, applying a second voltage higher than the first voltage to the first electrodes, and during the third period, applying the scan pulse to the second group for addressing the light-emitting cells formed along the second group. A difference between the first voltage and the second voltage is smaller than a difference between voltages applied to the first electrodes and the second electrodes during the sustain period.

One embodiment of the present invention provides a plasma display device. The device includes a PDP including a plurality of scan electrodes, a plurality of sustain electrodes, and a plurality of address electrodes formed in a direction crossing the plurality of scan electrodes and sustain electrodes. The scan electrodes include first scan electrodes that are a group of scan electrodes located adjacent to one another and second scan electrodes that are another group of scan electrodes that are also located adjacent to one another. The PDP has a plurality of cells formed where the scan and sustain electrodes cross over the address electrodes. The device also includes a driver for selecting light-emitting cells from cells formed along the first scan electrodes during a first period of an address period, and selecting light-emitting cells from cells formed along the second scan electrodes during a second period of the address period. The driver applies a second voltage higher than a first voltage to the plurality of scan electrodes while the first voltage is being applied to the sustain electrodes during a third period occurring between the first period and the second period. A difference between the first voltage and the second voltage is smaller than a difference between the voltages applied to the plurality of scan electrodes and the plurality of sustain electrodes during a sustain period.

One embodiment of the present invention provides a method for driving a plasma display panel in a plasma display device. The plasma display device includes driving electrodes. The driving electrodes include scan electrodes, sustain electrodes, and address electrodes formed in a direction crossing the scan electrodes and the sustain electrodes. The plasma display panel includes discharge cells that are formed at crossings of the scan electrodes and the sustain electrodes with the address electrodes. The plasma display device is driven during frames of time. Each frame is divided into a plurality of subfields. Each subfield includes a reset period followed by an address period followed by a sustain period. Wall charges are accumulated at the discharge cells during the reset period. Light-emitting cells are selected during the address period and emit light for forming an image that is displayed by the plasma display panel during the sustain period. The plasma display device further includes a temperature detector coupled to the plasma display panel for detecting a temperature of the plasma display panel. During each address period, the method includes applying first driving waveforms to the driving electrodes for addressing a first subset of the discharges cells, detecting the temperature of the plasma display panel, and determining whether the temperature of the plasma display panel is greater than a reference temperature. If the temperature of the plasma display panel is determined not to be greater than the reference temperature, the method includes applying the first driving waveforms to the driving electrodes for addressing a second subset of the discharges cells. If the temperature of the plasma display panel is determined to be greater than the reference temperature, the method includes applying second driving waveforms to the driving electrodes. Application of the second driving waveforms substantially restores wall charges lost from the second subset of the discharge cells while the first subset of the discharge cells are is being addressed.

### BRIEF DESCRIPTION OF THE DRAWINGS

FIG. 1 is a block diagram of a first plasma display device according to an exemplary embodiment of the present invention.

FIG. 2 shows plasma display device driving waveforms according to a first exemplary embodiment of the present invention.

FIGS. 3A, 3B and 3C show wall charge states during an address period of the plasma display device being driven using the driving waveforms according to the first exemplary embodiment of the present invention.

FIG. 4 shows plasma display device driving waveforms according to a second exemplary embodiment of the present invention.

FIG. 5 shows plasma display device driving waveforms according to a third exemplary embodiment of the present invention.

FIG. 6 is a block diagram of a second plasma display device according to an exemplary embodiment of the present invention.

FIG. 7 is a flowchart illustrating the operation of the controller shown in FIG. 6.

### DETAILED DESCRIPTION OF THE EMBODIMENTS

In the following detailed description, the term “wall charge” refers to charges formed close to an electrode on a wall (for example, a dielectric layer) of a discharge cell. Although wall charges do not actually come in contact with an electrode, the wall charges will be described as being “formed” or “accumulated” on the electrode. The term “wall voltage” refers to a potential formed on the wall of a discharge cell by wall charges.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variation is within a range allowed in design constraints or in the case that the variation is caused due to a parasitic component that is usually disregarded by a person of ordinary skill in the art. Furthermore, a threshold voltage of semiconductor devices, such as transistors and diodes, is much lower than a discharge voltage. It is therefore considered that the threshold voltage is approximately 0V.

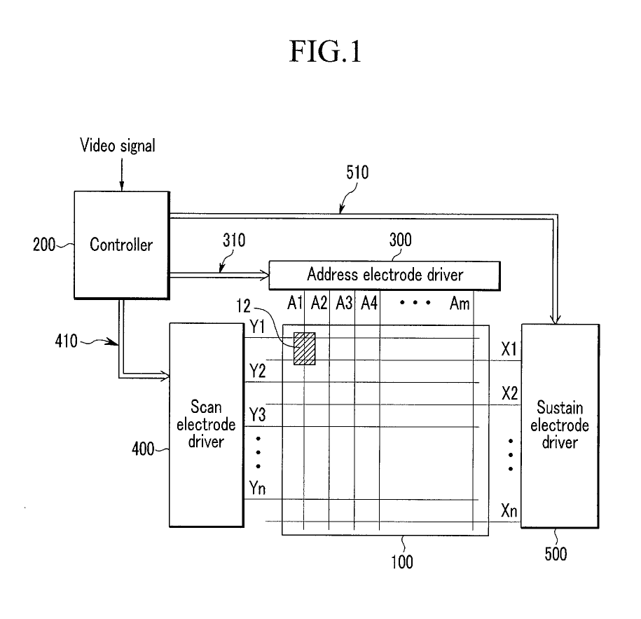

FIG. 1 is a block diagram of a first plasma display device according to an exemplary embodiment of the present invention. As shown in FIG. 1, the first plasma display device according to the exemplary embodiment of the present invention includes a PDP 100, a controller 200, an address electrode driver 300, a scan electrode driver 400 and a sustain electrode driver 500.

The PDP 100 includes a plurality of address electrodes A1-Am extending in a column direction, and a plurality of sustain electrodes X1-Xn and scan electrodes Y1-Yn extending in a row direction. The plurality of scan electrodes Y1-Yn and sustain electrodes X1-Xn are arranged in pairs. The scan electrodes Y1-Yn and the sustain electrodes X1-Xn, which are adjacent to each other, and the address electrodes A1-Am crossing the scan electrodes Y1-Yn and sustain electrodes X1-Xn form discharge cells.

It is to be noted that the driving waveforms, according to various embodiments of the present invention, can be applied to panels having various structures and the structure presented for PDP 100 is only one example of a panel that may be driven using the driving waveforms of the embodiments of the present invention.

The controller 200 receives a video signal from the outside, and outputs an address electrode driving control signal 310, a sustain electrode driving control signal 510 and a scan electrode driving control signal 410. Further, the controller 200 drives the PDP during one frame by dividing the frame into a plurality of subfields. Each subfield includes a reset period, an address period and a sustain period.

The address electrode driver 300 receives the address electrode driving control signal 310 from the controller 200, and applies a display data signal for selecting a discharge cell to be displayed to the address electrodes A1-Am.

The scan electrode driver 400 receives the scan electrode driving control signal 410 from the controller 200, and applies a driving voltage to the scan electrodes Y1-Yn.

The sustain electrode driver 500 receives the sustain electrode driving control signal 510 from the controller 200, and applies a driving voltage to the sustain electrodes X1-Xn.

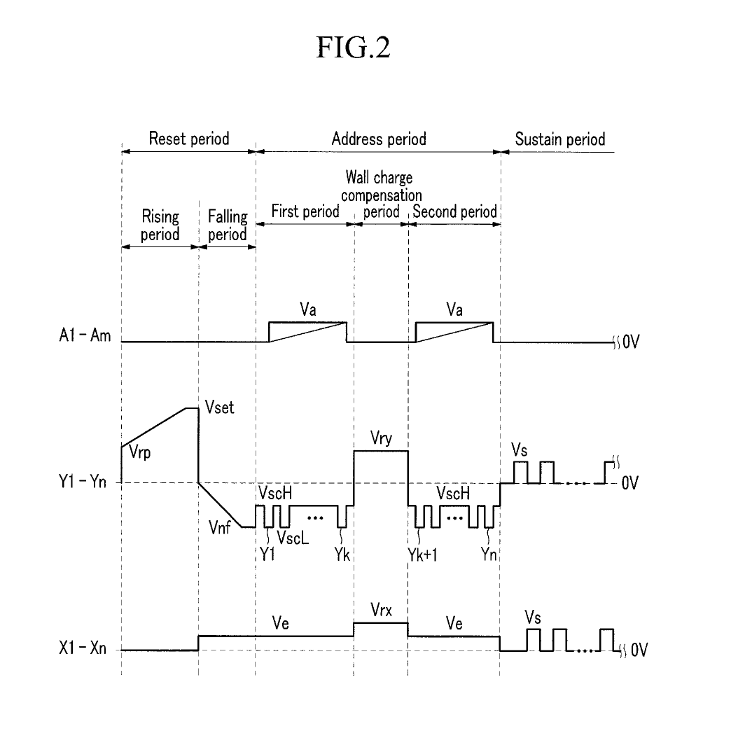

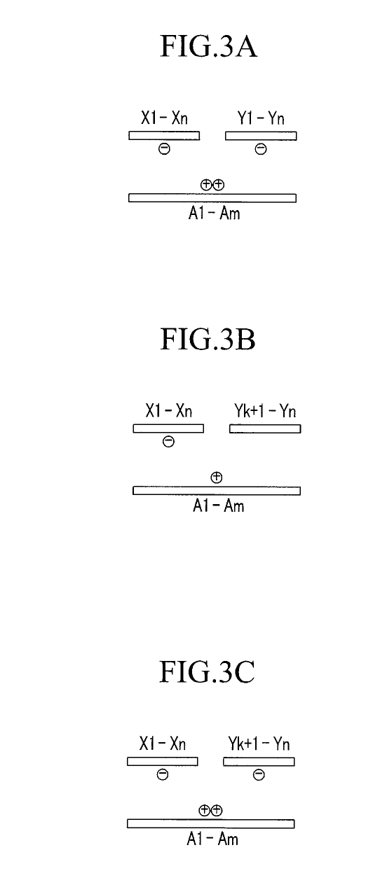

Driving waveforms according to a first exemplary embodiment of the present invention, for driving a plasma display device, will be described below with reference to FIG. 2, and FIGS. 3A, 3B and 3C.

FIG. 2 shows the driving waveforms according to the first exemplary embodiment of the present invention. FIGS. 3A to 3C show the wall charge state during an address period for driving the plasma display device that is driven by the driving waveforms of the first exemplary embodiment of the present invention.

As illustrated in FIG. 2, each subfield for driving the plasma display device includes a reset period, an address period and a sustain period. The address period includes a first period, a wall charge compensation period and a second period.

The reset period includes a rising period and a falling period. During the rising period of the reset period, the voltage of the scan electrodes Y1-Yn gradually increases from a voltage Vrp to a voltage Vset while the address electrodes A1-Am and the sustain electrodes X1-Xn are maintained at a reference voltage (0V in FIG. 2). FIG. 2 shows that, during the rising period, the voltage of the scan electrodes Y1-Yn increases in a ramp pattern. However, instead of a ramp, waveforms of different forms that gradually increase may be applied to the scan electrodes Y1-Yn. While the voltage of the scan electrodes Y1-Yn increases, a weak discharge is generated between the scan electrodes Y1-Yn and the sustain electrodes X1-Xn and between the scan electrodes Y1-Yn and the address electrodes A1-Am. Thus, negative (−) wall charges are formed on the scan electrodes Y1-Yn and positive (+) wall charges are formed on the sustain electrodes X1-Xn and the address electrodes A1-Am. In this case, if the voltage of the scan electrodes Y1-Yn gradually increases, wall charges are formed such that the sum of an externally applied voltage and a wall voltage of a cell are kept at a discharge firing voltage (Vf) state as weak discharge is generated in the cell. Further, in the reset period, the state of all of the cells is to be reset. Therefore, the voltage Vset is a high voltage such that discharge can occur in cells having all conditions.

During the falling period of the reset period, the voltage of the scan electrodes Y1-Yn gradually decreases from the voltage 0V to a voltage Vnf while the sustain electrodes X1-Xn are kept at a voltage Ve and the address electrodes A1-Am are kept at the reference voltage 0V. FIG. 2 shows that the voltage of the scan electrodes Y1-Yn decreases in a ramp pattern. However, waveforms having other gradually decreasing patterns can be applied to the scan electrodes Y1-Yn instead of a decreasing ramp. While the voltage of the scan electrodes Y1-Yn decreases, the negative (−) wall charges that have been formed on the scan electrodes Y1-Yn and the positive (+) wall charges that have been formed on the sustain and address electrodes X1-Xn and A1-Am during the rising period are erased as a weak discharge is generated between the scan and sustain electrodes Y1-Yn and X1-Xn and between the scan and address electrodes Y1-Yn and A1-Am. Consequently, the negative (−) wall charges of the scan electrodes Y1-Yn are decreased. The positive (+) wall charges of the sustain electrodes X1-Xn are erased and give rise to negative (−) wall charges. The positive (+) wall charges of the address electrodes A1-Am are also decreased so that they are suitable for address operation. Accordingly, wall charges after the reset period have a wall charge state as illustrated in FIG. 3A. The wall charge state is set such that address discharge is performed stably.

During an address period of a general plasma display device, a scan pulse is sequentially applied to all of the scan electrodes, and an address voltage is applied to an address electrode corresponding to the light-emitting cells in order to select the light-emitting cells from among all the discharge cells of the plasma display panel. However, in a cell corresponding to a scan electrode to which the scan pulse is applied later in time, the wall charges remaining after the reset period may be lost. As the wall charge state (FIG. 3A) set in the reset period changes, and as the charges are lost with the passing of time, the wall charge state is changed to a wall charge state illustrated in FIG. 3B. Low address discharge may occur due to the loss of wall charges.

For example, the plasma display panel of the plasma display device may include n scan electrodes Y1-Yn. During the address period, a scan pulse may be used for addressing the cells located along each scan electrode. The scan pulse may be applied to the n scan electrodes Y1-Yn in a sequential manner. Then, the scan electrodes located before the other scan electrodes, receive the scan pulse earlier and the electrodes located toward the end receive the scan pulse later. For example, the first k scan electrodes Y1-Yk receive the scan pulse before the last n-k scan electrodes Yk+1-Yn. The wall charges remaining after the reset period on the address electrodes At each cell are added to the voltages applied to the electrodes during the address period to generate the address discharge in the cell. The wall charges remaining on the address electrodes Are lost with passage of time after the reset period. By the time the sequential scan pulse reaches the scan electrodes Yk+1-Yn located toward the end of the group of scan electrodes Y1-Yn, the cells located along these electrodes may have lost the wall charge resulting from the preceding reset period. Then, the state of wall charges in these cells will not be appropriate for generating an address discharge when the scan pulse reaches their corresponding scan electrodes Yk+1-Yn. Embodiments of the present invention restore the wall charges of the cells located along the scan electrodes Yk+1-Yn, that receive their respective scan pulses later than their preceding scan electrodes Y1-Yk, in order to enable a stable address discharge in all of the cells of the panel.

Accordingly, in an exemplary embodiment of the present invention, a period is added during which wall charges lost during the address period are compensated so that the address period includes the first period, the wall charge compensation period and the second period.

During the first period, while the voltage Ve is applied to the sustain electrodes X1-Xn, a scan pulse having a voltage VscL is sequentially applied to the scan electrodes Y1-Yk. At this time, a voltage Va is applied to a subset of the address electrodes A1-Am that correspond to the discharge cells that are selected to emit light during the following sustain period. These discharge cells are selected among the plurality of discharge cells formed along the scan electrodes Y1-Yk to which the voltage VscL is being applied. As a result, address discharge is generated between the subset of the address electrodes A1-Am to which the voltage Va is being applied and the scan electrodes Y1-Yk to which the voltage VscL is being applied. The cells located at crossings of these electrodes are addressed for a subsequent sustain discharge. During the first period, an address discharge is also generated between the scan electrodes Y1-Yk to which the voltage VscL is being applied and the sustain electrodes X1-Xn to which the voltage Ve is being applied. Thus, positive (+) wall charges are formed on the scan electrodes Y1-Yk, and negative (−) wall charges are formed on the address electrodes A1-Am and X1-Xn, in the cells where the address discharge occurs. The voltage VscL may be set to be the same or lower than the voltage Vnf. Further, a voltage VscH higher than the voltage VscL is applied to the scan electrodes Y1-Yk during the time that the voltage VscL is not being applied to these electrodes, and the reference voltage (0V in FIG. 2) is applied to the address electrodes A1-Am of the discharge cells that are not being selected.

During the wall charge compensation period, while the address electrodes A1-Am are kept at the reference voltage (0V in FIG. 2), a voltage Vrx is applied to the sustain electrodes X1-Xn and a voltage Vry is applied to the scan electrodes Y1-Yn. In this case, the voltage Vry is higher than the voltage Vrx, and a difference between the voltage Vrx and the voltage Vry is smaller than a difference between voltages applied to the sustain electrodes X1-Xn and the scan electrodes Y1-Yn in the sustain period.

The difference between the voltages applied to the sustain electrodes X1-Xn and the scan electrodes Y1-Yn in the sustain period corresponds to a voltage that can generate discharge in addressed cells. If the difference between voltages applied to the sustain electrodes X1-Xn and the scan electrodes Y1-Yn during the wall charge compensation period is greater than or the same as the voltage difference between these same electrodes during the sustain period, cells addressed in the first period may generate discharge before reaching the sustain period. Accordingly, the difference between the voltage Vrx and the voltage Vry is kept smaller than the difference between voltages applied to the sustain electrodes X1-Xn and the scan electrodes Y1-Yn in the sustain period. Further, the voltage Vry is lower than the voltage Vset of the reset period. In order to maintain the state of a cell that has already been addressed, the voltage Vry is kept lower than the voltage Vset that was used for resetting the state of all of the cells by generating discharge in all of the cells.

After the reset period is over, the wall charges in the cells are in the state shown in FIG. 3A. Positive (+) wall charges are accumulated on the address electrodes A1-Am, and negative (−) wall charges are accumulated on the sustain electrodes X1-Xn and the scan electrodes Y1-Yn at each cell. Thereafter, the wall charge state of FIG. 3A experiences loss due to discharge between the wall charges during the first period. Therefore the wall charge state of the discharge cells to which the scan pulse has not been applied in the first period, i.e. cells along the scan electrodes Yk+1-Yn, changes to the state illustrated in FIG. 3B. FIG. 3B illustrates a state where wall charges of the address electrodes A1-Am and Yk+1-Yn are lost. This state of wall charges may result in a low address discharge. Therefore, in a state where wall charges are lost as illustrated in FIG. 3B, the voltage Vrx is applied to the sustain electrodes X1-Xn and the voltage Vry is applied to the scan electrodes Y1-Yn. The difference between the voltage Vrx and the voltage Vry is at a level that does not cause the addressed cells to generate discharge. Accordingly, the scan electrodes Y1-Yk retain their addressed wall charge state, negative (−) wall charges are accumulated on the scan electrodes Yk+1-Yn that were not addressed in the first period, and positive (+) wall charges are accumulated on the address electrodes A1-Am at cells along the scan electrodes Yk+1-Yn that were not addressed in the first period. As described above, in the wall charge compensation period, negative (−) wall charges are accumulated on the sustain electrodes X1-Xn and the scan electrodes Yk+1-Yn, and positive (+) wall charges are accumulated on the address electrodes A1-Am, thereby compensating for lost wall charges. A wall charge state after the wall charge compensation period is complete is illustrated in FIG. 3C. It can be seen from FIG. 3C that after the wall charge compensation period, the loss in the wall charges has been compensated and the wall charges return to the wall charge state after the reset period that was shown in FIG. 3A.

Thereafter, during the second period, the scan pulse is applied to the remaining electrodes Yk+1-Yn to which the scan pulse was not applied during the first period, and the discharge cells that are intended to emit light are selected. In other words, while the voltage Ve is applied to the sustain electrodes X1-Xn, a scan pulse having the voltage VscL is sequentially applied to the remaining electrodes Yk+1-Yn. During the second period, the scan pulse is not applied to the k electrodes Y1-Yk to which the voltage VscL was applied in the first period. In this case, if the voltage Va is applied to the address electrodes A1-Am that pass through the discharge cells that are intended to emit light, among the plurality of discharge cells formed by the scan electrodes Yk+1-Yn to which the voltage VscL is being applied, address discharge occurs between the address electrodes A1-Am to which the voltage Va is applied and the scan electrodes Yk+1-Yn to which the voltage VscL is applied. Address discharge also occurs between the scan electrodes Yk+1-Yn to which the voltage VscL is applied and the sustain electrodes X1-Xn to which the voltage Ve is applied. Accordingly, positive (+) wall charges are formed on the scan electrodes Yk+1-Yn, and negative (−) wall charges are formed on the address electrodes A1-Am and X1-Xn. Further, the voltage VscH higher than the voltage VscL is applied to the scan electrodes Yk+1-Yn when the voltage VscL is not being applied to these electrodes. The reference voltage (0V in FIG. 2) is applied to the address electrodes A1-Am of the unselected discharge cells. Accordingly, even a discharge cell that is selected late, can be selected with reduced possibility of low address discharge.

Thereafter, in the sustain period, sustain pulses alternately having a high level voltage (a voltage Vs in FIG. 2) and a low level voltage (the voltage 0V in FIG. 2) are applied to the scan electrodes Y1-Yn and the sustain electrodes X1-Xn with opposite phases. In other words, when the voltage Vs is applied to the scan electrodes Y1-Yn, the voltage 0V is applied to the sustain electrodes X1-Xn, and when the voltage Vs is applied to the sustain electrodes X1-Xn, the voltage 0V is applied to the scan electrodes Y1-Yn. Thus, discharge is generated between the scan electrodes Y1-Yn and the sustain electrodes X1-Xn by means of the sum of the voltage difference between Vs and 0V and a voltage difference formed between the scan electrodes Y1-Yn and the sustain electrodes X1-Xn due to the previous address discharge. Thereafter, the process of applying the sustain pulse to the scan electrodes Y1-Yn and the sustain electrodes X1-Xn is repeated a number of times corresponding to the weight value of the corresponding subfield.

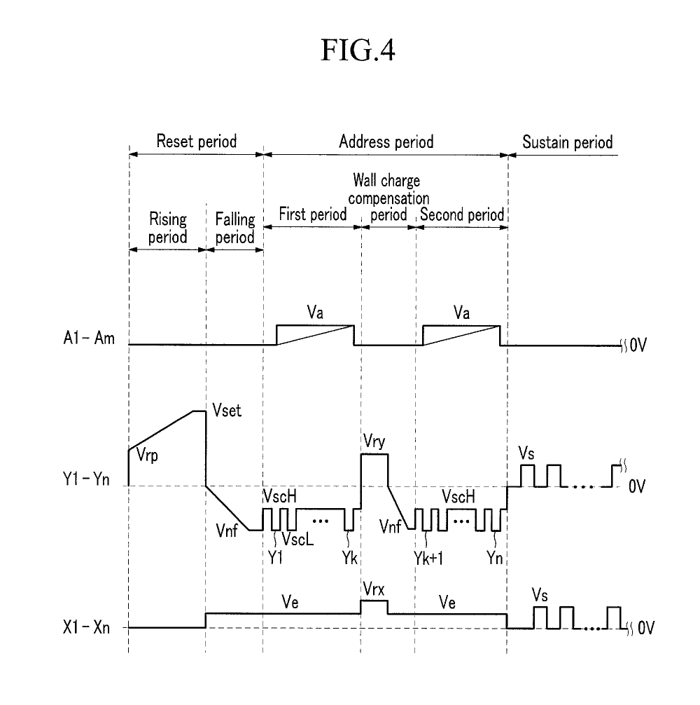

FIG. 4 shows driving waveforms according to a second exemplary embodiment of the present invention that may be used for driving a plasma display device. Only the differences between the driving waveform according to the second exemplary embodiment of the present invention and the driving waveform according to the first exemplary embodiment will be described in order to avoid redundancy. The differences between the two waveforms occur during the wall charge compensation period.

As shown in FIG. 4, during a first portion of the wall charge compensation period, while the address electrodes A1-Am maintain the voltage 0V, the voltage Vrx is applied to the sustain electrodes X1-Xn and the voltage Vry is applied to the scan electrodes Y1-Yn. Thereafter, in the remaining portion of the wall charge compensation period, while the address electrodes A1-Am maintain the voltage 0V, the voltage Ve is applied to the sustain electrodes X1-Xn, and the voltage of the scan electrodes Y1-Yn gradually decreases from the voltage 0V to the voltage Vnf. If the falling portion of the wall charge compensation waveform is similar to the falling waveform of the reset period described above, while the voltage of the scan electrodes Y1-Yn gradually decreases from the voltage 0V to the voltage Vnf, a large amount of wall charges accumulated on the scan electrodes Y1-Yn may be erased. As a result, the amount of wall charges can be controlled with more precision. That is, during the wall charge compensation period, a wall charge state almost similar to the reset period may be obtained by gradually decreasing the voltage of the scan electrodes Y1-Yn from the voltage 0V to the voltage Vnf as in the falling period of the reset period.

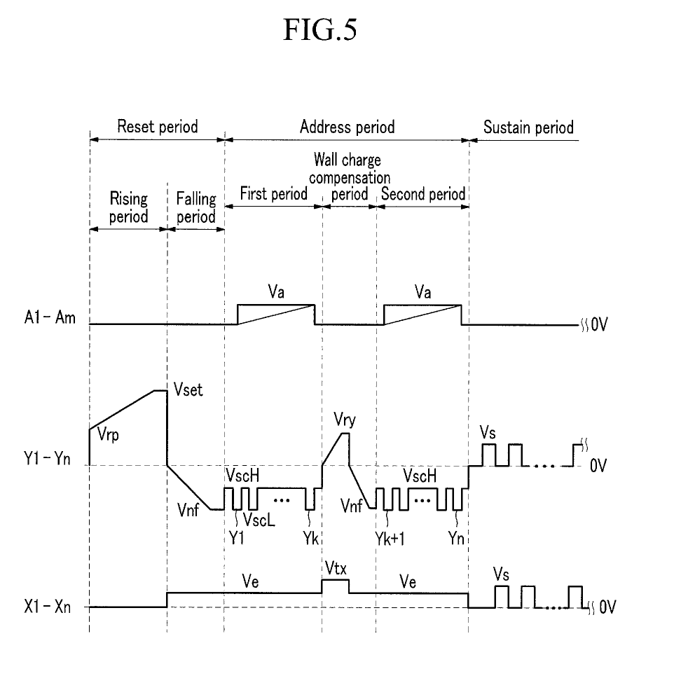

FIG. 5 shows driving waveforms according to a third exemplary embodiment of the present invention for driving a plasma display device. In the third exemplary embodiment of the present invention, during the first portion of the wall charge compensation period, the voltage of the scan electrodes Y1-Yn is gradually increased from the voltage 0V to the voltage Vry and then maintained at the voltage Vry.

In more detail, during the first portion of the wall charge compensation period, while the address electrodes A1-Am are at the voltage 0V and the sustain electrodes X1-Xn are at the voltage Vrx, the voltage of the scan electrodes Y1-Yn gradually increases from the voltage 0V to the voltage Vry and then remains at the voltage Vry. Thereafter, while the address electrodes A1-Am maintain the voltage 0V and the sustain electrodes X1-Xn receive the voltage Ve, the voltage of the scan electrodes Y1-Yn is gradually decreased from the voltage 0V to the voltage Vnf. If instead of a gradual increase, the voltage Vry is abruptly applied to the scan electrodes Y1-Yn, there is a possibility that a strong discharge may occur because of the large difference between the voltage Vry and the voltages that were applied to the scan electrodes Y1-Yn during the first period. For this reason, the voltage of the scan electrodes Y1-Yn is gradually increased from the voltage 0V to the voltage Vry, enabling more stable discharge.

As described above, the scan pulse is applied to some of the scan electrodes during the first period of the address period, and to the remaining scan electrodes during the second period of the address period. In the embodiments shown, the first period and the second period of the address period are separated by the wall charge compensation period. However, in alternative embodiments of the present invention, more than one wall charge compensation period may be included in the address period that may occur several times during the address period.

Discharge characteristics of the plasma display device vary depending on temperature. When temperature is high, discharge between wall charges is facilitated and more wall charge is lost. Accordingly, an exemplary embodiment in which the wall charge compensation waveform is added only when temperature is high for the purpose of stable address discharge at high temperature is described below.

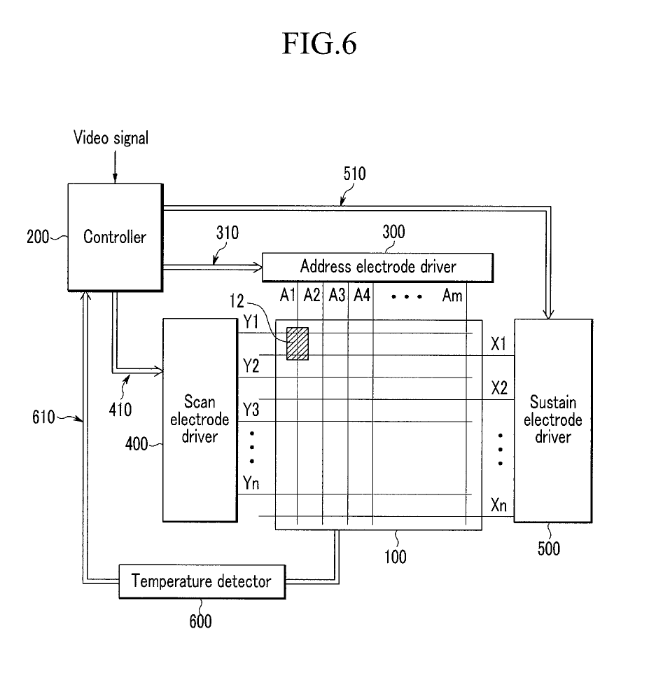

FIG. 6 is a block diagram of a second plasma display device according to the exemplary embodiments of the present invention. As shown in FIG. 6, the second plasma display device according to an exemplary embodiment of the present invention includes a PDP 100, a controller 200, an address electrode driver 300, a scan electrode driver 400, a sustain electrode driver 500 and a temperature detector 600.

Except for the temperature detector 600 that is included in the plasma display device of FIG. 6, the device shown in FIG. 6 is similar to the device shown in FIG. 1. Accordingly, description of similar parts is omitted.

The temperature detector 600 senses the temperature of the PDP 100, and sends a signal 610 indicating the detected temperature to the controller 200. In a fourth exemplary driving method according to embodiments of the present invention, the temperature of the PDP is detected in order to determine whether to add the wall charge compensation period. Therefore, for this embodiment, the temperature detector 600 is added to the plasma display device.

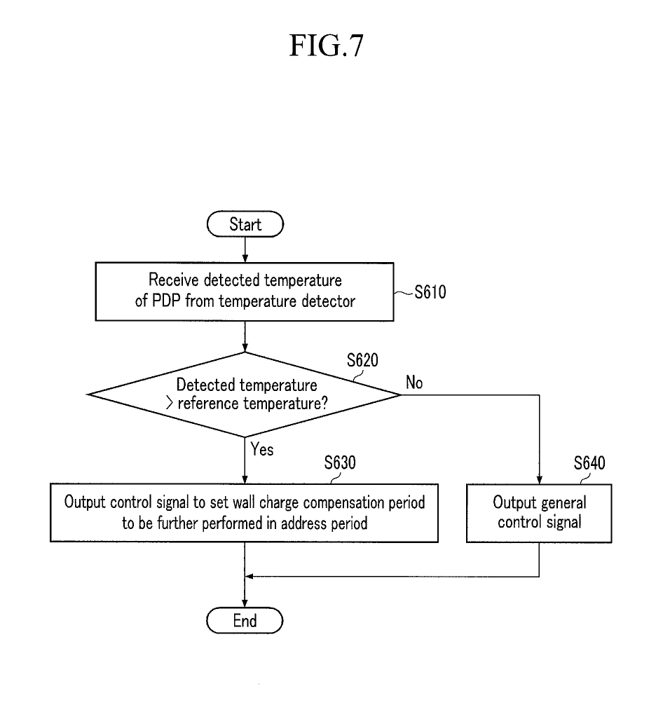

FIG. 7 is a flowchart illustrating the operation of the controller shown in FIG. 6. The controller 200 receives the temperature of the PDP 100, which is detected by the temperature detector 600, from the temperature detector 600 at step S610, and determines whether the detected temperature is higher than a reference temperature at step S620.

The reference temperature is the temperature at which wall charges may be lost in the plasma display device. The reference temperature may be measured experimentally. In some embodiments, the reference temperature may be set to about 25 degrees C. In other embodiments, the reference temperature may be set to another appropriate temperature.

At step S620, if the detected temperature of the PDP 100 is determined to be lower than the reference temperature, the controller 200 outputs its general control signals at step S640. The output control signals 310, 410, 510 are sent to the address electrode driver 300, the scan electrode driver 400 and the sustain electrode driver 500, respectively. However, if at step S620 the detected temperature of the PDP 100 is determined to be higher than the reference temperature, then, at step S630, the controller 200 outputs control signals which cause a wall charge compensation period to be included in the address period.

Accordingly, through the operation of the controller, the wall charge compensation waveform is added only when there is a possibility that low address discharge may occur due to the loss of wall charges, thus enabling more efficient driving of the plasma display device.

In accordance with exemplary embodiments of the present invention, a plasma display device and a driving method thereof are provided in which stable address discharge can be performed by including a wall charge compensation period in the address period.

Embodiments of the present invention include one or more wall charge compensation periods within the address period. During the compensation periods, voltages somewhat similar in waveform to the reset waveforms are applied to the scan and sustain electrodes. The voltages applied to the scan and sustain electrodes replenish the wall charges of the cells along the later scan electrodes while keeping the voltage difference between the electrodes sufficiently small to prevent a sustain discharge in the addressed cells along the earlier scan electrodes. Because higher temperatures accelerate the loss of wall charges in the cells, a temperature detector is included in one embodiment that signals the controller to include a compensation period when a higher than a reference temperature is detected at the panel.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method of driving a plasma display device, the plasma display device including a plurality of first electrodes, a plurality of second electrodes, a plurality of third electrodes formed in a direction crossing the first electrodes and the second electrodes, and cells being formed at crossings of the plurality of first electrodes and the plurality of second electrodes with the plurality of third electrodes, the plurality of the first electrodes being divided into a first group and a second group, the first electrodes of the first group being adjacent one another and the first electrodes of the second group being adjacent one another, the plasma display device being driven during frames of time, each frame being divided into a plurality of subfields, each subfield including an address period followed by a sustain period, light-emitting cells being selected during the address period and emitting light for forming an image being displayed during the sustain period, at least one address period including a first period, a second period, and a third period, the method comprising:
during the first period, applying a scan pulse to the first group for addressing the light-emitting cells formed along the first group;
during the second period, while applying a first voltage to the plurality of second electrodes, applying a second voltage higher than the first voltage to the plurality of first electrodes; and
during the third period, applying the scan pulse to the second group for addressing the light-emitting cells formed along the second group,
wherein a difference between the first voltage and the second voltage is smaller than a difference between voltages applied to the plurality of first electrodes and the plurality of second electrodes during the sustain period.

2. The method of claim 1, further comprising:
applying a third voltage to the third electrodes during the first period and the third period for selecting the light-emitting cells from among the cells of the plasma display device,
wherein the second voltage is higher than the third voltage, and
wherein the second voltage has a polarity opposite to polarity of the scan pulse.

3. The method of claim 2, wherein a reset period precedes the at least one address period and the at least one address period further includes a fourth period occurring between the second period and the third period, the method further comprising:
during the fourth period, gradually decreasing a voltage of the plurality of first electrodes from a fifth voltage to a sixth voltage while a fourth voltage is being applied to the plurality of second electrodes,
wherein the sixth voltage is equal to a final voltage applied to the plurality of first electrodes during the reset period.

4. The method of claim 3, wherein the fourth voltage is lower than the first voltage, and the fifth voltage is lower than the second voltage.

5. The method of claim 4, wherein the at least one address period further includes a fifth period occurring between the first period and the second period, the method further comprising:
during the fifth period, gradually increasing the voltage of the plurality of first electrodes from a seventh voltage to the second voltage.

6. The method of claim 5, wherein the seventh voltage is lower than the second voltage.

7. The method of claim 6, wherein the fifth voltage and the seventh voltage are ground voltages.

8. The method of claim 1, wherein the at least one address period including the first period, the second period, and the third period occurs only when temperature of the plasma display device is higher than a reference temperature.

9. A method for driving a plasma display panel in a plasma display device, the plasma display device including driving electrodes, the driving electrodes including scan electrodes, sustain electrodes, and address electrodes formed in a direction crossing the scan electrodes and the sustain electrodes, the plasma display panel including discharge cells being formed at crossings of the scan electrodes and the sustain electrodes with the address electrodes, the plasma display device being driven during frames of time, each frame being divided into a plurality of subfields, each subfield including a reset period followed by an address period followed by a sustain period, wall charges being accumulated at the discharge cells during the reset period, light-emitting cells being selected during the address period and emitting light for forming an image being displayed by the plasma display panel during the sustain period, the plasma display device further including a temperature detector coupled to the plasma display panel for detecting a temperature of the plasma display panel, the method comprising during each address period:
applying first driving waveforms to the driving electrodes for addressing a first subset of the discharges cells;
detecting the temperature of the plasma display panel;
determining whether the temperature of the plasma display panel is greater than a reference temperature;
if the temperature of the plasma display panel is determined not to be greater than the reference temperature, applying the first driving waveforms to the driving electrodes for addressing a second subset of the discharges cells; and
if the temperature of the plasma display panel is determined to be greater than the reference temperature, applying second driving waveforms to the driving electrodes;
wherein wall charges are being lost from the second subset of the discharge cells while the first subset of the discharge cells are being addressed, and
wherein the second driving waveforms substantially restore the wall charges lost from the second subset of the discharge cells.

10. The method of claim 9,
wherein applying first driving waveforms to the driving electrodes includes applying first address waveforms, first sustain waveforms, and first scan waveforms respectively to the address electrodes, the sustain electrodes and the scan electrodes, and
wherein applying second driving waveforms to the driving electrodes includes applying second address waveforms, second sustain waveforms, and second scan waveforms respectively to the address electrodes, the sustain electrodes and the scan electrodes.

11. The method of claim 10,
wherein the second scan waveforms and the second sustain waveforms include a first constant voltage and a second constant voltage respectively, and
wherein a difference between the first constant voltage and the second constant voltage is smaller than a difference between voltages applied to the scan electrodes and the sustain electrodes during the sustain period.

12. The method of claim 10,
wherein the first scan waveforms include negative scan pulses sequentially applied to the scan electrodes, and
wherein the second scan waveforms include a rising voltage including positive values followed by a falling voltage including negative values being applied to the scan electrodes of the second subset of the discharge cells.

13. The method of claim 12,
wherein the first address waveforms are positive and the second address waveforms are ground voltage, and
wherein the second sustain waveforms are more positive than the first sustain waveforms.

14. A plasma display device, comprising:
a plasma display panel including a plurality of scan electrodes, a plurality of sustain electrodes, a plurality of address electrodes formed in a direction crossing the plurality of scan electrodes and the plurality of sustain electrodes, and a plurality of cells formed at crossings of the scan electrodes and the sustain electrodes with the address electrodes, the plurality of scan electrodes including first scan electrodes and second scan electrodes, the first scan electrodes being located adjacent one another and the second scan electrodes being located adjacent one another; and
a driver for driving the plasma display panel during periods including an address period and a sustain period, the driver selecting light-emitting cells from cells formed along the first scan electrodes during a first period of the address period, and selecting light-emitting cells from cells formed along the second scan electrodes during a second period of the address period,
wherein the driver applies a first voltage to the plurality of sustain electrodes while applying a second voltage, higher than the first voltage, to the plurality of scan electrodes during a third period occurring after the first period and before the second period, and
wherein a difference between the first voltage and the second voltage is smaller than a difference between voltages applied to the plurality of scan electrodes and the plurality of sustain electrodes during the sustain period.

15. The plasma display device of claim 14,
wherein the driver gradually decreases the voltage applied to the plurality of scan electrodes from a fourth voltage to a fifth voltage while applying a third voltage to the plurality of sustain electrodes during a fourth period occurring between the second period and the third period, and
wherein the fifth voltage is a final voltage applied to the plurality of scan electrodes during a reset period for driving the plasma display panel.

16. The plasma display device of claim 15,
wherein the third voltage is lower than the first voltage, and
wherein the fourth voltage is lower than the second voltage.

17. The plasma display device of claim 16, wherein during a fifth period occurring between the first period and the third period, the driver gradually increases the voltage applied to the plurality of scan electrodes from a sixth voltage to the second voltage.

18. The plasma display device of claim 17,
wherein the sixth voltage is lower than the second voltage, and
wherein the fourth voltage and the sixth voltage are ground voltages.

19. The plasma display device of claim 18, further comprising:
a temperature detector for detecting a temperature of the plasma display panel and for providing the temperature of the plasma display panel to the driver,
wherein only when the temperature of the plasma display device is higher than a reference temperature, the address period includes the third period, the fourth period and the fifth period.

20. The plasma display device of claim 14, wherein the plurality of scan electrodes consist of the first scan electrodes and the second scan electrodes.
